(19) United States
(12) Patent Application Publication
(10) Pub. No.: US 2004/0191032 A1
(43) Pub. Date: Sep. 30, 2004

(54) Bi-directional arm and storage system

(75) Inventors: Richard F. Foulke, Stoneham, MA (US); Richard F. Foulke JR., Hampstead, NH (US); Carl T. Ito, Scottsdale, AZ (US); Richard F. Foulke JR., Hampstead, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: R. Foulke Development Company, LLC, Salem, NH

(21) Appl. No.: 10/622,261

(22) Filed: Jul. 18, 2003

Related U.S. Application Data
(60) Provisional application No. 60/397,559, filed on Jul. 19, 2002.

(51) Int. Cl. B65G 1/00

(52) U.S. Cl. 414/280

(57) ABSTRACT

An extendable arm for placing and moving items includes a base and an arm unit movably mounted to the base. The arm unit is configured for linear movement in a first direction relative to the arm unit for extending beyond the base in the first direction and for linear movement in a second direction relative to the arm unit which is opposite to the first direction for extending beyond the base in the second direction.

### RELATED APPLICATION

This application claims the benefit of U.S. Provisional Application No. 60/397,559, filed Jul. 19, 2002. The entire teachings of the above application are incorporated herein by reference.

### BACKGROUND

Semiconductor manufacturing facilities require extensive specialized storage or stocker systems for storing manufacturing items such as wafers and tools. These storage systems typically include a robot for placing and removing stored items from a series of storage racks. The space required for the robot adds to the size of the storage system. Typically, wafers are stored in “Front Opening Universal Pods”, or FOUPs, which are then stored in racks.

### SUMMARY

The present invention provides an extendable arm for placing and moving items which can be employed with storage or stocker systems to minimize the size of the system.

The extendable arm typically includes a base and an arm unit movably mounted to the base. The arm unit is configured for linear movement in a first direction relative to the arm unit for extending beyond the base in the first direction and for linear movement in a second direction relative to the arm unit which is opposite to the first direction for extending beyond the base in the second direction.

In preferred embodiments, the arm unit includes more than one movable stage for increased reach and compact retraction in a neutral position. A drive mechanism drives the more than one stage. In one embodiment, the drive mechanism can be a single drive, while in other embodiments, the drive mechanism includes multiple drives. The items are held by the arm by at least one of the top, bottom and a side of the item.

The present invention also provides a storage system including a first storage rack and a second storage rack spaced apart from the first storage rack. A robot is positioned between the first and second storage racks for placing and removing items from the racks. The robot includes an extendable arm having an arm unit configured for linear movement in a first direction relative to the arm unit for placing and removing items from the first rack, and for linear movement in a second direction relative to the arm unit which is opposite to the first direction for placing and removing items from the second rack.

In preferred embodiments, the items in both racks are positioned to face in the same direction.

The present invention also provides a gripper arm assembly including a gripper arm for placing and moving items that is movably mounted to a vertical member for vertical movement. The gripper arm is supported by one or more cables passing over a pulley and balanced by a counter weight. A brake is coupled to the pulley for braking the pulley and vertical movement of the gripper arm.

The present invention also provides a retainer for a FOUP including a series of protrusions for supporting a bottom of the FOUP. The protrusions have a length and extend into recesses within the FOUP. A retaining member is spaced above the FOUP by a distance less than the length of the protrusions to prevent disengagement of the protrusions and the recesses by lifting of the FOUP.

In preferred embodiments, the retaining member can be moved to provide access to the FOUP.

The present invention further provides a method of forming a wafer product including storing a manufacturing item in a storage rack. The manufacturing item is removed from the storage rack with an extendable arm. The extendable arm includes a base and an arm unit movably mounted to the base. The arm unit is configured for linear movement in a first direction relative to the arm unit for extending beyond the base in the first direction and for linear movement in a second direction relative to the arm unit which is opposite to the first direction for extending beyond the base in the second direction. The manufacturing item is in the storage rack in one of the first and second directions. The manufacturing item is conveyed to at least one processing station where process steps are conducted for forming the wafer product.

In one embodiment, the wafer product is a chip and the manufacturing item is a wafer. In another embodiment, the manufacturing item is a reticle.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 depicts a top view of an embodiment of a typical prior art storage rack such as for storing “Front Opening Universal Pods” or FOUPs for temporary or long term storage. The top view also shows a FOUP held by a robot in process of begin rotated to be placed or retrieved from the rear storage rack. The front of the FOUP is facing the center aisle of the stocker.

FIG. 2 depicts a top view of an embodiment of the present invention with storage racks such as for storing FOUPs for temporary or long term storage. A FOUP held by a robot is in the process of being moved to be placed or retrieved from the rear storage rack.

FIG. 3 depicts a front view of an embodiment of a storage rack such as for storing FOUPs in storage locations. Some FOUPs are shown in the front view of the rack. The front view also shows a manual input/output port. An automatic input/output port can be included at an upper region of the rack. The bi-directional arm can be employed with such a rack to place and remove FOUPs from the storage bin or input/output ports.

FIG. 4 depicts an end view of an embodiment of a robot operating on a horizontal track in an aisle between two storage racks. The robot has a vertical axis post to which an extendable or bi-directional arm is mounted for placing and removing FOUPs from the storage bin locations.

FIGS. 5A-5C are schematic representations of the bi-directional arm moving an object such as a FOUP from a storage bin or input/output location at the right (or forward position) FIG. 5A, to a central position in the aisle FIG. 5B, and then to a storage bin location at the left (or rear position) FIG. 5C. The bi-directional arm has a conveyance platform with location pins for supporting and conveying the FOUP which can move along a linear horizontal axis from the right to the left (forward and backward).

FIG. 6A depicts a side view, FIG. 6B depicts a top view, and FIG. 6C depicts an end view of the bi-directional arm of FIG. 4 with the conveyance platform located in a central position. The bi-directional arm has three stages which slide along a series of linear bearing rails (best seen in the end view) and are driven by a linear motor. The conveyance platform is extended by a belt mechanism.

FIG. 7A depicts a side view, FIG. 7B depicts a top view, and FIG. 7C depicts a perspective view of the bi-directional arm of FIG. 4 with the conveyance platform extended to the right or a forward position.

FIG. 8A depicts a side view, FIG. 8B depicts a top view, and FIG. 8C depicts a perspective view of the bi-directional arm of FIG. 4 with the conveyance platform extended to the left or a rear position.

FIGS. 9A-9C depict schematic representations of another embodiment of the bi-directional arm moving an object such as a FOUP from a storage bin or input/output location at the right (or a forward position) FIG. 9A, to a central position in the aisle FIG. 9B, and then to a storage bin location at the left (or a rear position) FIG. 9C. This embodiment employs two linear motors. A belt mechanism moves the conveyance platform.

FIGS. 10A-10C depict a schematic representation of the continuous drive belt mechanism to drive the conveyance plate.

FIG. 11 depicts an embodiment of a process flow for semiconductor manufacturing from a bare wafer to the consumer.

FIG. 12 depicts an embodiment of the bi-directional arm mount and passive FOUP retainer system.

### DETAILED DESCRIPTION OF THE PREFERRED EMBODIMENTS

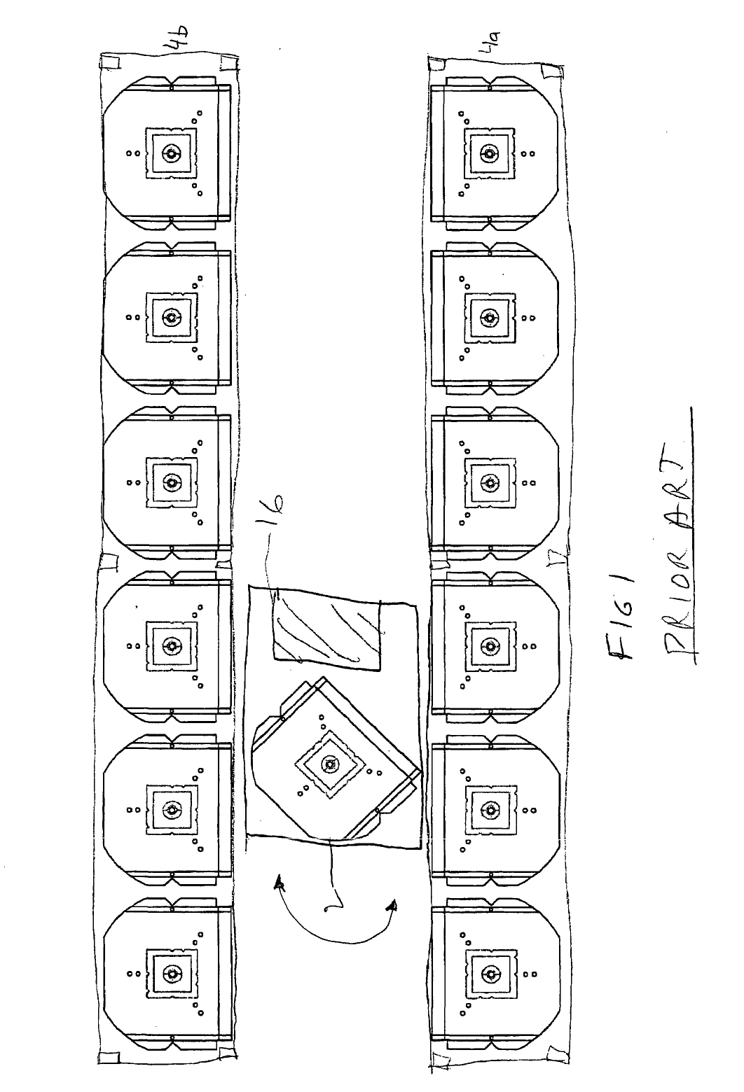

Referring to FIG. 1, in the prior art, FOUPs 2 are stored in a typical prior art storage rack configuration as shown with FOUPs facing each other. The robot 16 holds one FOUP 2 which is shown in the process of being rotated while being moved from the front storage rack 4a to the rear storage rack 4b.

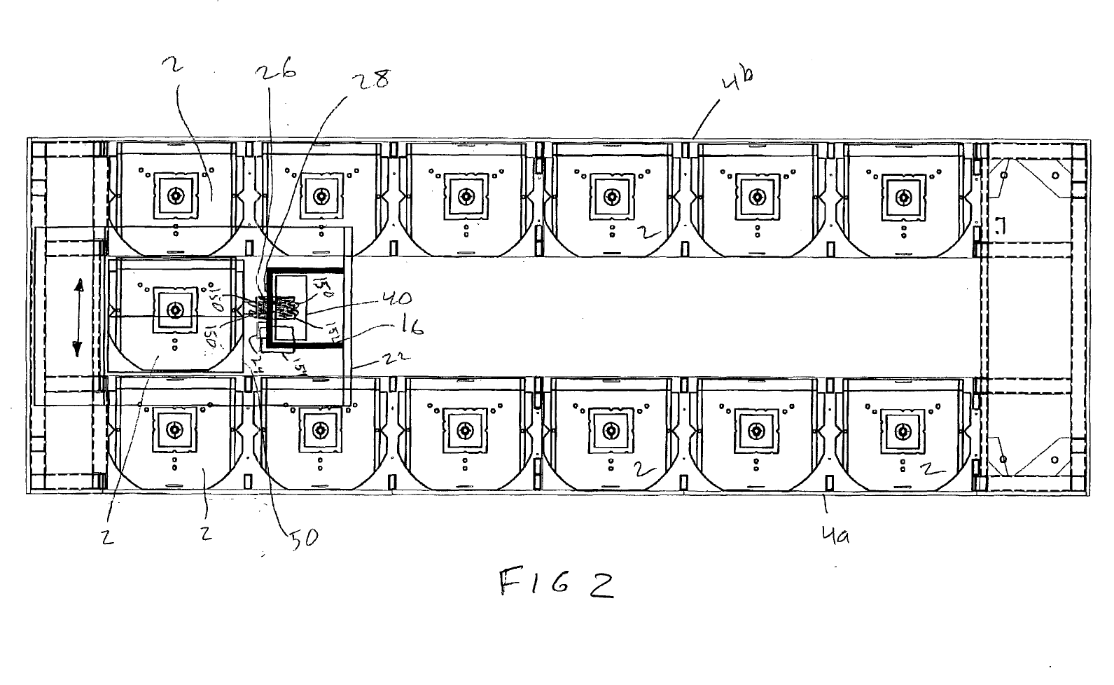

Referring to the embodiment of the present invention of FIG. 2, the FOUPs 2 are stored in storage racks in the same orientation. Robot 16 has an extendable or bi-directional arm 50 which can move a FOUP 2 from the front storage rack 4a to the rear storage rack 4b, in the direction of the arrow, without rotation. Storage racks 4a and 4b can be placed much closer together using this orientation because space is not needed to rotate a FOUP 2 as shown in the prior art of FIG. 1. Only enough space is needed for clearance for vertical and horizontal motion of the FOUP 2 from bin to bin. This clearance space can be under one-half inch between the FOUP 2 on the bi-directional arm 50 and the racks 4a and 4b. However, clearances can vary depending upon the situation at hand. In the embodiment shown in FIG. 2, the racks 4a and 4b can be fifteen inches apart. In the prior art shown in FIG. 1, the storage racks 4a and 4b are typically twenty-four inches apart.

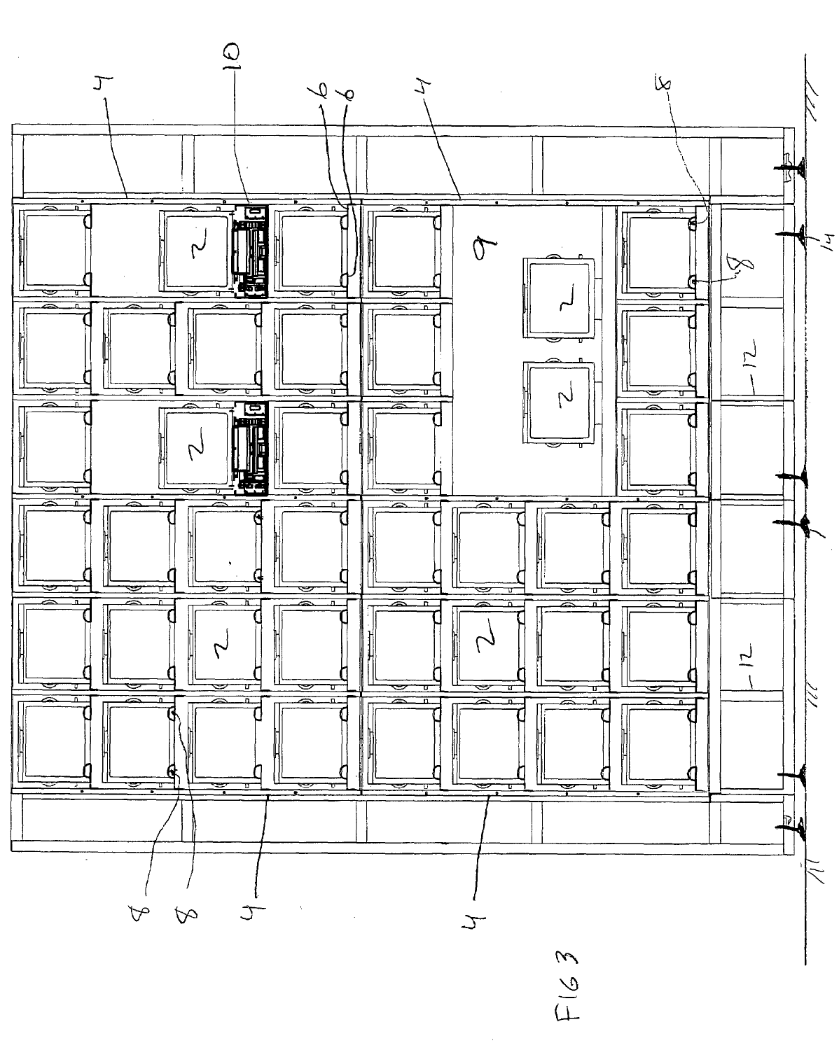

Referring to FIG. 3, the FOUPs 2 can be stored in storage racks 4a and 4b which are formed from storage rack modules 4. The FOUPs sit on shelves 6 containing one location or retaining pin 8 (also known as kinematic pin) on each shelf. A manual input/output module port 9 contains two load stations to manually input or output a FOUP 2 into the system. An automatic input/output port 10 can be included in an upper region for access to a factory automated material transport system. A lower frame section 12 supports the storage rack modules 4. Leveling feet 14 are mounted to the lower frame to level the modules horizontally.

The rack modules shown are sized to hold three columns of FOUPs 2 vertically and four rows of FOUPs 2 for a total of twelve FOUPs per module. The rack modules 4 can be stacked together both horizontally and vertically to make a larger array of FOUPs 2.

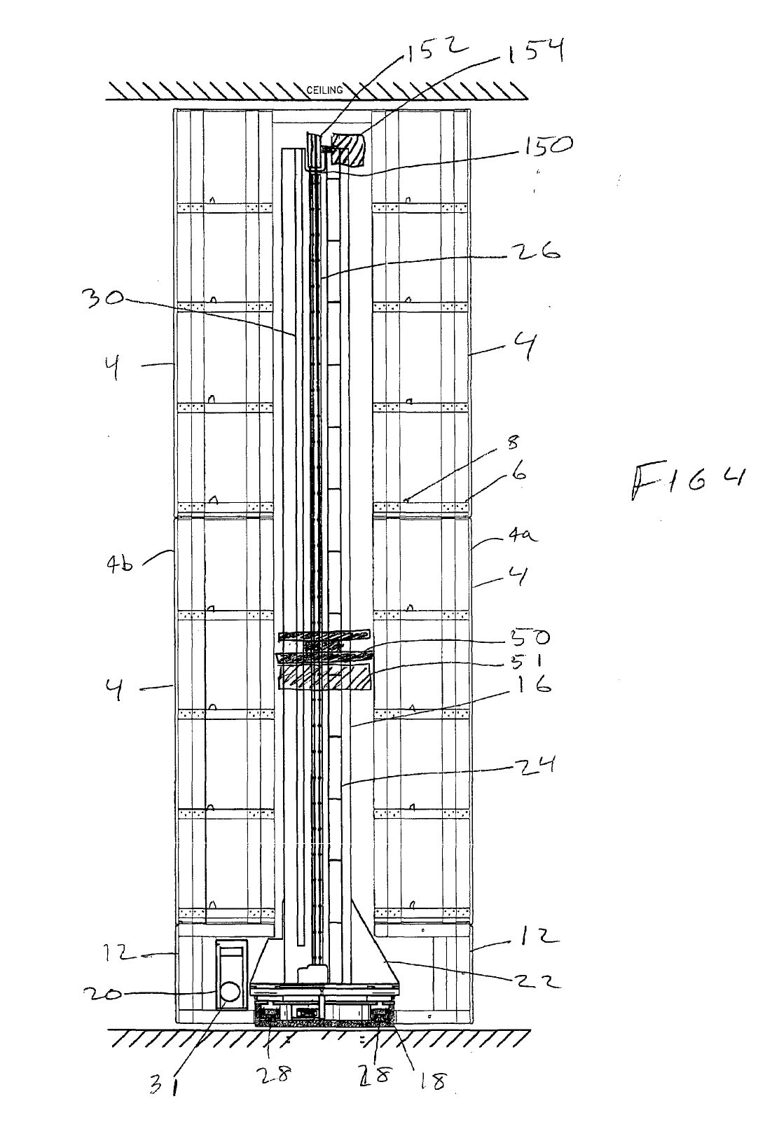

Referring to the embodiments depicted in FIGS. 2 and 4, multiple sets of storage racks 4 are mounted on corresponding multiple sets of lower frame sections 12 with a space in between for a robot 16 to traverse. The robot 16 traverses horizontally on linear bearing rails 28. The linear bearing rails 28 are typically mounted to a u-shaped frame 18 for support. The robot 16 allows vertical motion of the bi-directional arm 50. The robot 16 moves a horizontal arm mount 52 holding the bi-directional arm 50 using linear motors 24 on a vertically mounted linear bearing 26. A linear encoder 30 is mounted parallel to the linear rail 26 and linear motor 24. A horizontally mounted service loop box 20 is mounted parallel to the linear bearing rails 28 and next to the u-shaped frame 18. The service loop box 20 contains the cables for power and communication to the moving robot 16. A blower 31 is mounted on the service loop box to exhaust any particles in the service loop box. Diagonal stiffeners 22 are mounted to aid in stability of the robot 16.

The robot 16 traverses longitudinally up and down the aisle between the racks 4a and 4b. The bi-directional arm 50 is attached to the robot 16 by attaching to the linear bearing blocks on the linear bearing rail 26 to allow travel in the vertical direction. A counter weight 40 is connected to the bi-directional arm assembly 50 using cables 150 passing over grooves in a pulley 152 at the top of the robot tower 16. The grooves prevent pinching of the cable. The counter weight 40 is sized to balance the bi-directional arm assembly 50 and FOUP 2. An electromechanical brake 154 is attached to the pulley 152 to provide braking action of the vertical motion of the bi-directional arm 50. The space between FOUP 2 and the storage rack 4a and a FOUP 2 resting in the storage rack 4a can be one-half inch.

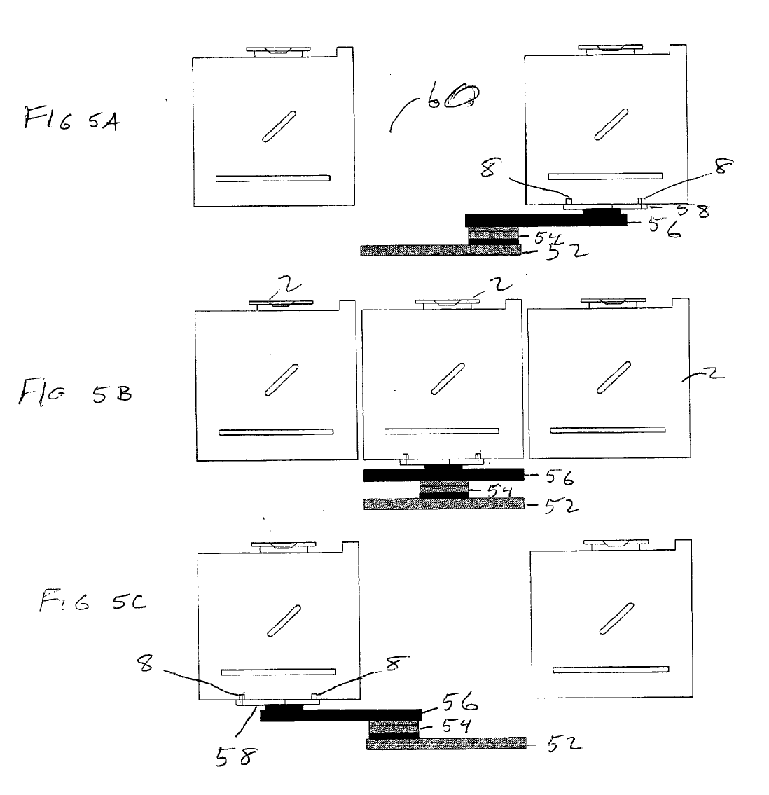

FIGS. 5A-5C show in schematic fashion an embodiment of a bi-directional arm 50 consisting of baseplate or base stage 52, middle plate or stage 54, upper plate or stage 56 and conveyance platform 58 which slide or move relative to each other generally along a linear path or axis in an offset manner. The conveyance platform has three kinematic or retaining pins 8 attached to fit in the bottom grooves of the FOUP 2. FIG. 5A shows the bi-directional arm assembly 50 extended to one side on the right with the middle stage 54 at far right end of travel and upper stage 56 at far right end of travel and the conveyance platform or stage 58 at far right end of travel. FIG. 5B shows the bi-directional arm assembly 50 retracted to the middle position. The lower stage 52 and upper stage 56 are the dimensionally same length as the FOUP 2 to provide the minimum aisle width 60. FIG. 5C shows the bi-directional arm assembly 50 fully extended to the opposite side on the left to reach under FOUP 2. The power and data cables for driving the multiple stages may not need to be routed through all the stages requiring multiple service loops. The bi-directional arm 50 allows a closer spacing of the shelves 6 in the storage racks 4, thus increasing the possible storage density of the storage racks 4.

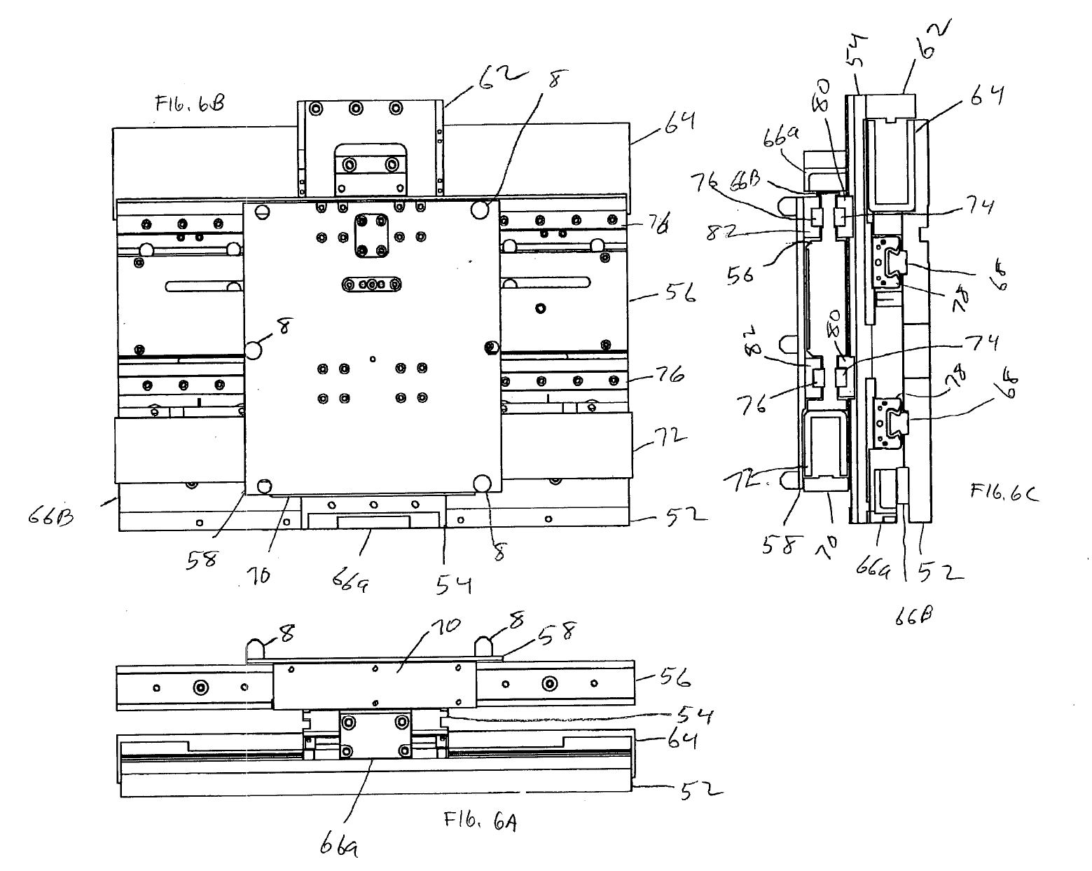

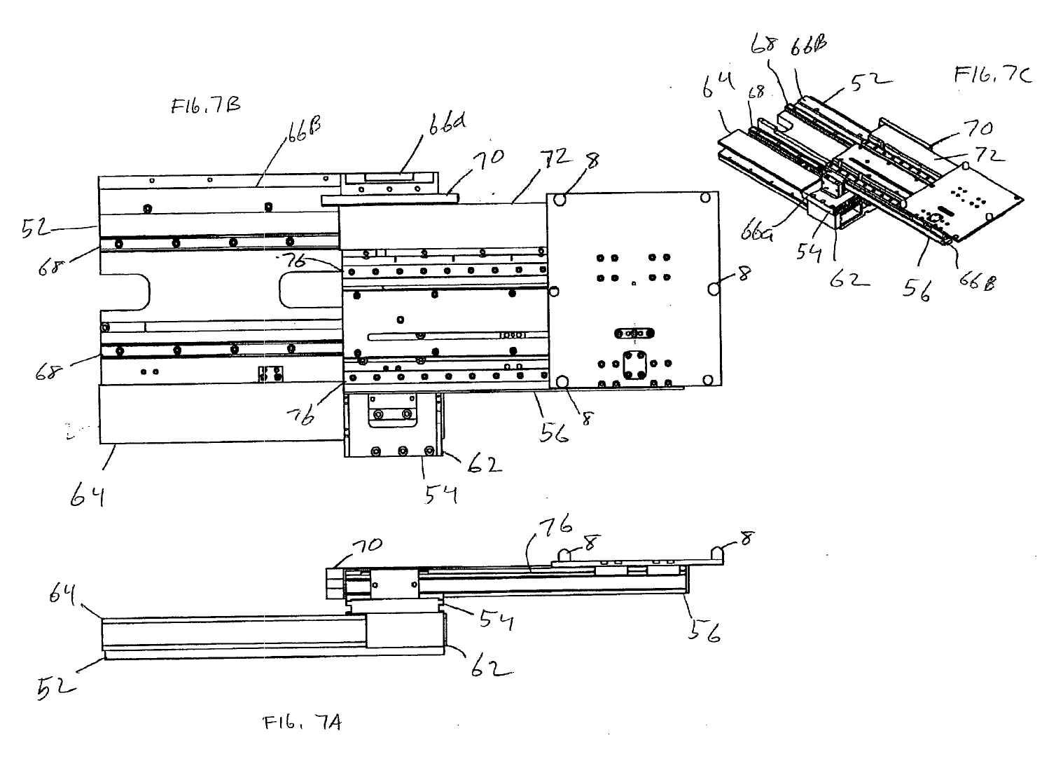

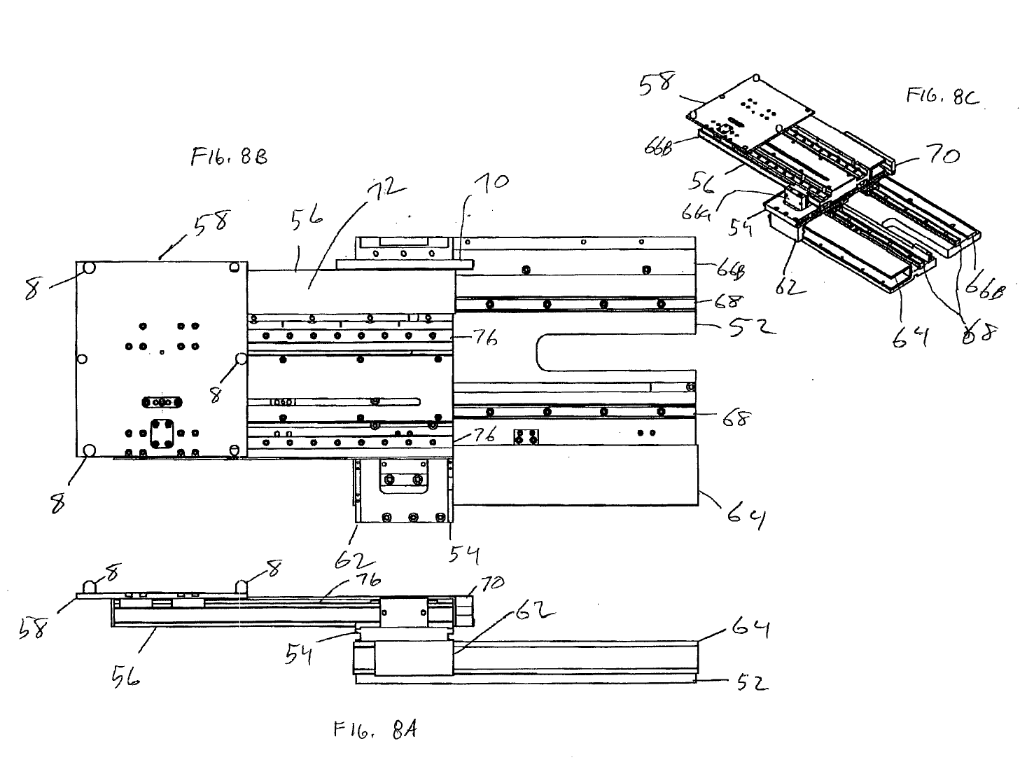

Referring to FIGS. 6A-8C, one embodiment of the present invention of the drive mechanism for the lower stage includes a linear motor with an electrical armature coil 62 attached to middle stage 54 and a magnet assembly 64 attached to the baseplate 52. A separate linear encoder head 66a and tape 66b is mounted parallel to each linear motor to provide motor commutation and position location information. A linear bearing rail 68 is attached parallel to the magnet assembly and the linear encoder scale on the baseplate 52. The drive mechanism for the upper stage 56 is similar, with an electrical armature coil 70 attached to the middle stage 54 and a magnet assembly 72 attached to the upper stage 56 and a linear bearing rail 74 attached to the upper stage 56 to provide directional stability between the upper stage 56 and the middle stage 54. A third linear bearing rail 76 is attached to the top of the upper stage for the conveyance platform. A linear bearing block 78 assembly for the lower stage 52 linear bearing rail is attached to the middle stage 54. Likewise, a linear bearing block assembly 80 for the upper stage 56 linear bearing rail is attached to the middle stage 54. A linear bearing block assembly 82 for the conveyance platform 58 is attached to the conveyance platform 58.

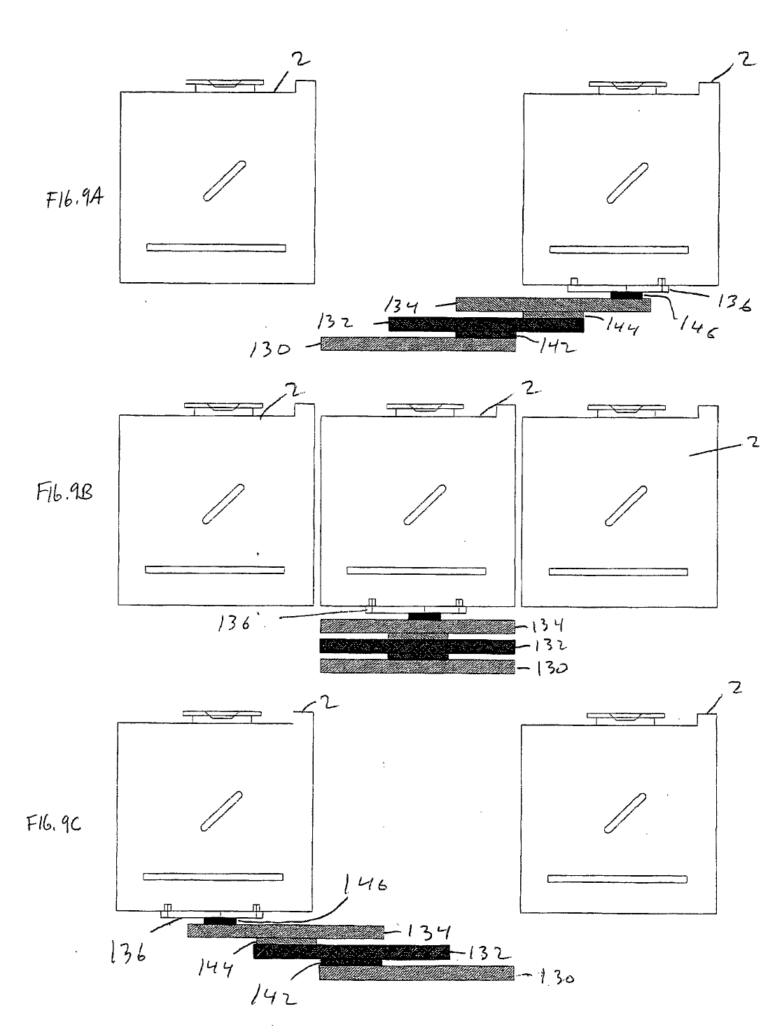

Referring to FIGS. 9A-9C, an alternative embodiment of the bi-directional arm in the present invention is shown. Three equal length stages are shown. The baseplate 130 remains fixed in the center position. The middle stage 132 moves to the left or right or side to side on a linear bearing rail 142. The upper stage 134 moves to the left or right on a linear bearing rail 144. The conveyance platform 136 moves to the left or right on a linear bearing rail 146. The stages can be connected together using a combination of belts, cables and drive motors.

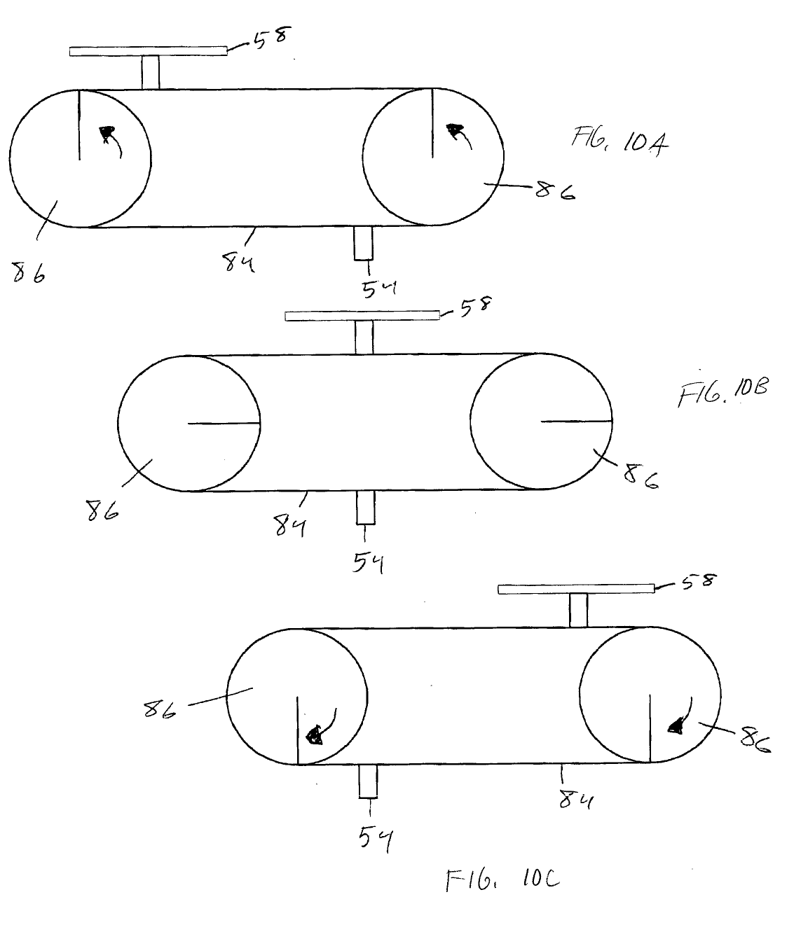

Referring to FIGS. 10A-10C, one embodiment in the present invention of the drive mechanism for the conveyance platform 58 is a continuous loop belt 84 drive mounted on two sprockets and to the conveyance stage 58 on the opposite side of the sprockets. When the upper stage motor drive is commanded to move, the belt rotates around the sprockets 86 with each side moving in opposite directions. With one side of the belt attached to the middle stage 54 and the other side attached to the conveyance platform 58 and moving in the opposite direction, the conveyance platform is moved in the same direction as the upper stage 56.

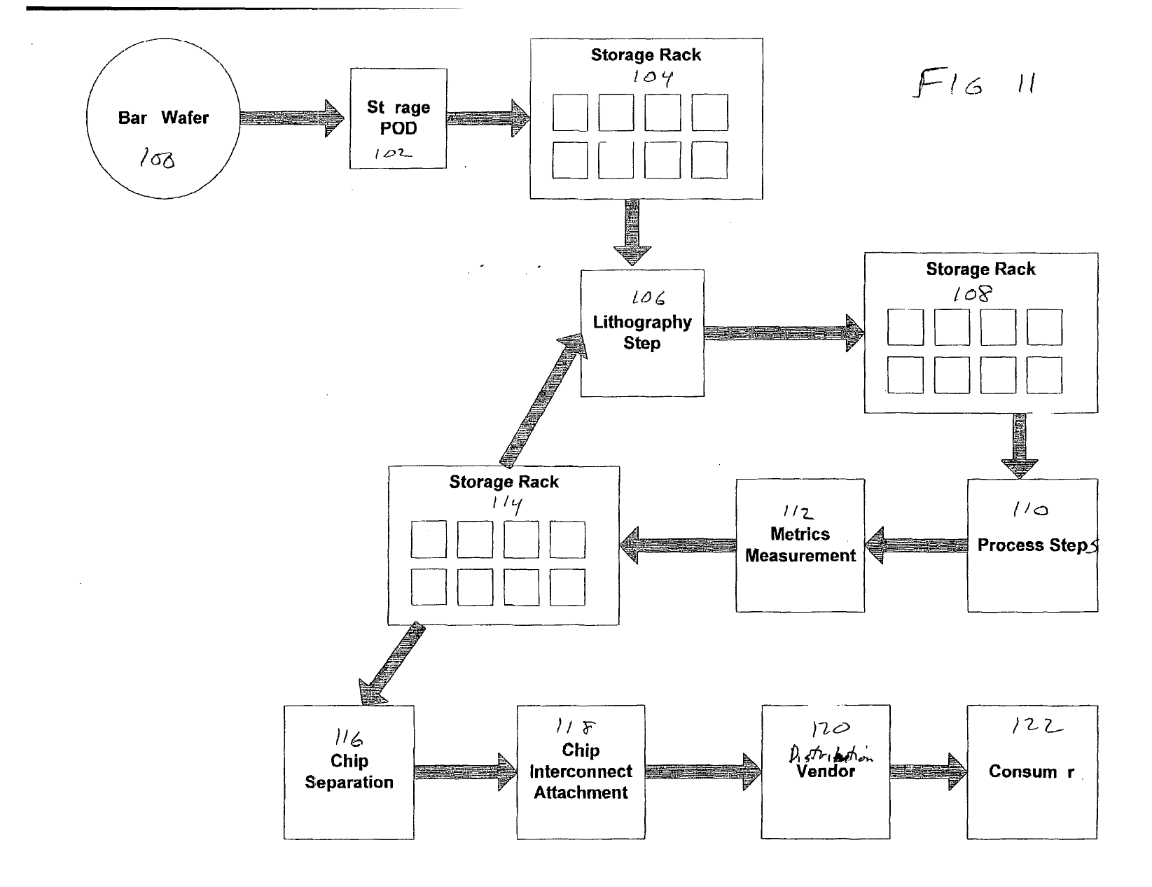

FIG. 11 depicts a sequence of process steps for the manufacture of wafer products such as semiconductor chips from blank bare wafers to the consumer. A bare wafer 100 is stored in a storage pod 102 such as a FOUP or SMIF pod or cassette. Several of these storage pods are stored in a storage rack 104 until needed for processing. The storage pods are transferred to lithography processing 106 and then can go into more storage racks 108 waiting for the process steps 110. After processing then metrics measurement 112 may be made and then put into more storage racks 114. Typically, twenty or more additional loops around the process loop will occur. Once the wafer has completed processing, the wafers are cut up during chip separation 116 into individual chips and the chip interconnect attachments 118 are attached. The completed chips are then delivered to a vendor 120 who will then deliver them to the end consumer 122. Each storage rack 104, 108 and 114 can include racks 4a and 4b with a robot 16 and bi-directional arm 50 for moving the storage pods. In addition, storage racks for storing tools such as reticles and including a robot 16 with a bi-directional arm 50 can be included in the process wherein reticles are conveyed to a process station.

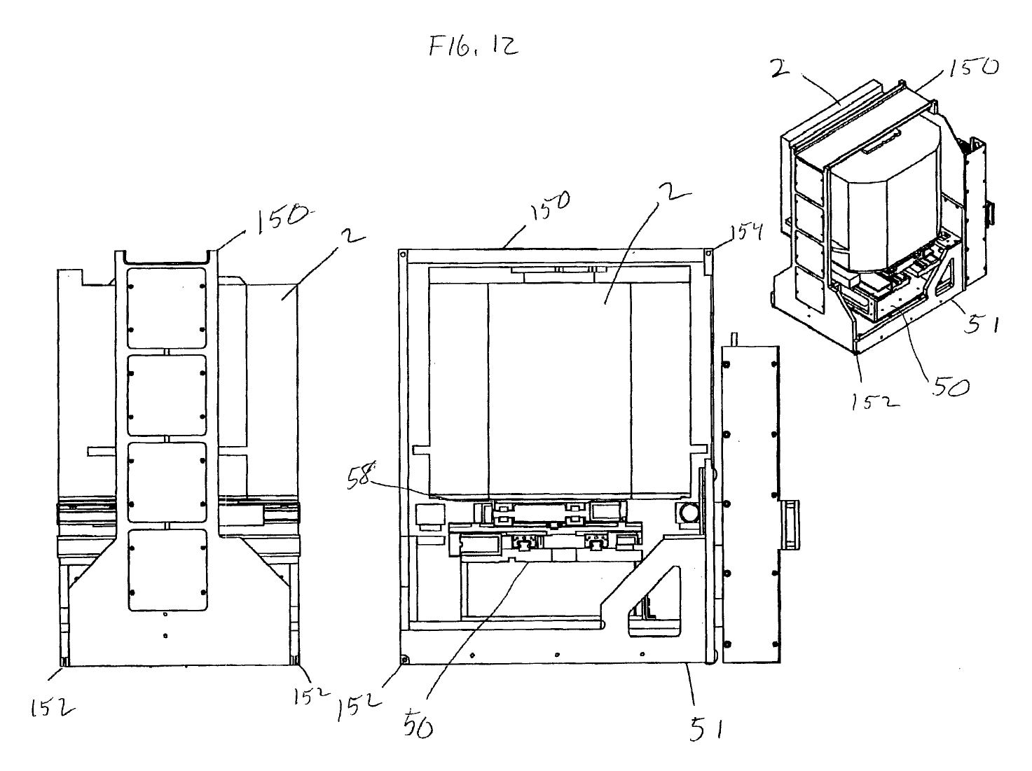

FIG. 12 depicts the bi-directional arm 50 and one embodiment of a bi-directional arm mount 51 with a passive FOUP retainer 150. The top cross member of the passive FOUP retainer 150 can be spaced above the FOUP 2, when the FOUP is seated properly on the kinematic pins 8 located on the conveyance plate 58. The kinematic or locating pins 8 are dimensionally taller than the space between the FOUP 2 and passive FOUP retainer top cross member 150 to keep the FOUP from lifting off the kinematic pins during movement of the bi-directional arm 50. The passive FOUP retainer 150 can be rotated on pins 152 out of the way to allow access to the FOUP 2 if required. Pin 154 holds the passive FOUP retainer 150 in place during normal operation and is removed to allow rotation. Alternatively, the passive FOUP retainer can be designed as a pocket to hold the FOUP 2 and require lifting of the FOUP 2 to clear the pocket.

In operation, a person can place a FOUP 2 into the input/output load port 9 to be placed into storage bin located in the storage rack 4. The robot will move to place the bi-directional arm 50 in proper position below the FOUP in the input/output load port. The bi-directional arm 50 will extend both the middle stage 54 and the upper stage 56 towards the FOUP 2. The conveyance platform 58 will also extend by virtue of the upper stage 56 extending relative to the middle stage 54. Once in proper position, the bi-directional arm assembly 50 will move vertically to engage the FOUP 2 on the kinematic or locating pins 8 on the conveyance plate 58. The bi-directional arm assembly 50 will continue moving vertically to allow the FOUP 2 to clear the kinematic pins 8 on the input/output port 9. Once the FOUP 2 is clear of all potential obstructions, the middle stage 54 and upper stage 56 will retract towards the middle position. When the bi-directional arm 50 has retracted all stages to the middle location, the bi-directional arm 50 can move both vertically and horizontally to a storage bin. Once the FOUP 2 is in position at a storage bin location, the bi-directional arm 50 will repeat the aforementioned steps to place the FOUP 2 onto the kinematic locating pins 8 on a shelf 6. Once the FOUP 2 is seated on the kinematic pins 8, the bi-directional arm 50 will retract to the center position to repeat the operation with another FOUP 2. A similar operation can occur at the automatic input/output port 10.

A benefit of using the storage technique described in the present invention is to minimize the footprint of the storage system. For example, a typical semiconductor facility is very costly to build and equip with process tools and storage racks. The cost per square foot is very high and much effort is entailed to reduce the space required for the non-productive storage of wafers and to allow more room for processing equipment. A typical semiconductor manufacturing facility may use as many as twenty to fifty storage racks for both short term and long term storage of wafers during their processing. The storage technique described in this invention achieves a smaller footprint and higher density for storage racks. Eliminating the need to rotate the object to be stored prior to placing the object onto the storage rack eliminates the space needed to rotate the object. The use of the bi-directional arm is one method to move objects from one location to another location inside the storage rack.

While this invention has been particularly shown and described with references to preferred embodiments thereof, it will be understood by those skilled in the art that various changes in form and details may be made therein without departing from the scope of the invention encompassed by the appended claims.

For example, other preferred embodiments can be made to store SMIF pods, wafer cassettes, reticles, or any other object such as common inventory items instead of FOUPs 2. Modifications to the conveyance platform 58 and storage rack 4 and shelves 6 can be made depending upon the situation at hand. Also, the conveyance platform 58 can be made to grip the object from the top or side in addition to the bottom of the object. An active gripper can be employed in place of a passive gripper on the conveyance platform, as required for the object. Typically, objects are stored on both sides of the track axis aisle in the same orientation such that if looking at the object from the track axis aisle, on one side the front of the object is visible and on the other side of the track axis aisle the rear of the object is visible. Alternatively, the objects can be stored such that the left side is visible from the aisle on one rack and the right side of the object is visible from the aisle on the opposite rack. Also, one rack could be eliminated thus having a rack only on one side of the aisle. The bi-directional arm can be used in a system with storage on one side and the input/output ports on the opposite side. This allows access to the stored items through a door without having to enter the system. The drive mechanism for the bi-directional arm 50 can be made from a single drive motor and belts or cables connecting the remainder of the stage. Also, drive motors can be placed on each stage to eliminate the use of belts. A rotary motor can be used in place of linear motors using either rack and pinion gearing or belts or cables. The drive mechanism for the vertical motion of the bi-directional arm or the lateral motion of the robot back and forth along the aisle can be a rotary motor with or without belts in place of linear motors. Wheels can be used in place of the linear bearing rails for linear motion. The robot 16 can also be constructed using either a single tower or multiple towers. Rotary encoders may be used in place of linear encoders. Alternatively, linear positioning technology using the linear motor magnets field or other similar technology can be used in place of the optical based linear encoders. A multi-axis angular motion arm can be mounted to the robot to reach and grip the object in place of the linear motion of the bi-directional arm. An optional rotator may be attached to the bi-directional arm 50 to allow high density storage of this objects such as reticles. By adding the rotator, the slide extension mechanism may not need to extend under or over the object in the storage rack. The rotator can also reduce the number of extension levels required. The rotator may facilitate rotation of the gripping means to permit insertion or retraction of the object in a specialized storage location. Various features of the present invention can be omitted or combined. The bi-directional arm can be operated in other orientations such as on edge, vertically or at an angle. The bi-directional arm can be used for non-storage uses.

What is claimed is:

1. An extendable arm for placing and moving items comprising:
a base;
an arm unit movably mounted to the base, the arm unit being configured for linear movement in a first direction relative to the arm unit for extending beyond the base in the first direction and for linear movement in a second direction relative to the arm unit which is opposite to the first direction for extending beyond the base in the second direction.

2. The arm of claim 1 in which the arm unit includes more than one movable stage for increased reach and compact retraction in a neutral position.

3. The arm of claim 2 further comprising a drive mechanism for driving said more than one stage.

4. The arm of claim 3 in which the drive mechanism is a single drive.

5. The arm of claim 3 in which the drive mechanism comprises multiple drives.

6. The arm of claim 1 in which the items are held by the arm by at least one of the top, bottom and a side of the item.

7. A storage system comprising:
a first storage rack;
a second storage rack spaced apart from the first storage rack; and
a robot positioned between the first and second storage racks for placing and removing items from the racks, the robot including an extendable arm having an arm unit configured for linear movement in a first direction relative to the arm unit for placing and removing items from the first rack, and for linear movement in a second direction relative to the arm unit which is opposite to the first direction for placing and removing items from the second rack.

8. The system of claim 7 in which the items in both racks are positioned to face in the same direction.

9. A gripper arm assembly comprising:
a gripper arm for placing and moving items that is movably mounted to a vertical member for vertical movement, the gripper arm being supported by a cable passing over a pulley and balanced by a counter weight; and
a brake coupled to the pulley for braking the pulley and vertical movement of the gripper arm.

10. A retainer for a FOUP comprising:
a series of protrusions for supporting a bottom of the FOUP, the protrusions having a length extending into recesses within the FOUP; and
a retaining member spaced above the FOUP by a distance less than the length of the protrusions to prevent disengagement of the protrusions and recesses by lifting of the FOUP.

11. The retainer of claim 10 in which the retaining member can be moved to provide access to the FOUP.

12. A method of forming a wafer product comprising:
storing a manufacturing item in storage rack;
removing the manufacturing item from the storage rack with an extendable arm, the extendable arm including a base and an arm unit movably mounted to the base, the arm unit being configured for linear movement in a first direction relative to the arm unit for extending beyond the base in the first direction and for linear movement in a second direction relative to the arm unit which is opposite to the first direction for extending beyond the base in the second direction, the manufacturing item being in the storage rack in one of the first and second directions; and
conveying the manufacturing item to at least one processing station where process steps are conducted for forming the wafer product.

13. The method of claim 12 in which the wafer product is a chip and the manufacturing item is a wafer.

14. The method of claim 12 in which the manufacturing item is a reticle.
